(19) United States
(12) Patent Application Publication
(10) Pub. No.: US 2026/0031357 A1
(43) Pub. Date: Jan. 29, 2026

(54) Electrodes for Energy Storage Device Comprising Binders having Hydrophilic Functionality

(71) Applicant: NANORAMIC, INC., Woburn, MA (US)

(72) Inventors: Luning Wang, Lynn, MA (US); Ji Chen, Natick, MA (US); Dave Jao, Malden, MA (US); Wanjun Ben Cao, Boston, MA (US); Nicolo Brambilla, Brookline, MA (US)

(21) Appl. No.: 19/121,910

(22) PCT Filed: Oct. 18, 2023
(86) PCT No.: PCT/US2023/077156

§ 371 Date: Apr. 17, 2025

Related U.S. Application Data
(60) Provisional application No. 63/417,127, filed on Oct. 18, 2022.

(51) Int. Cl. H01M 4/62; H01M 4/04; H01M 10/0525

(52) U.S. Cl. CPC H01M 4/622; H01M 4/0404; H01M 4/625; H01M 10/0525

(57) ABSTRACT

An electrode comprising a current collector and an active layer on the current collector, wherein the active layer comprises electrode active particles, electrically conducting material and a binder wherein the binder comprises a polymer selected from the group consisting of polyacrylamides, polymethacrylic acid, polyacrylic acid and salts thereof can be used in an energy storage device. The electrode can be made by providing a slurry comprising the electrically conductive elements, the binder and the electrode active material in water, alcohol or a combination thereof, and coating the slurry onto a current collector, and drying to remove the solvent.

### CROSS REFERENCE TO RELATED APPLICATIONS

This application claims the benefit of U.S. Application No. 63/417,127, filed on Oct. 18, 2022, which is incorporated herein by reference in its entirety.

### FIELD OF THE INVENTION

This invention relates to energy storage device, particularly lithium ion batteries, and electrodes used in such batteries.

### BACKGROUND OF THE INVENTION

Lithium batteries are used in many products including medical devices, electric cars, airplanes, and consumer products such as laptop computers, cell phones, and cameras. Due to their high energy densities, high operating voltages, and low-self discharges, lithium ion batteries have overtaken the secondary battery market and continue to find new uses in products and developing industries.

Generally, lithium ion batteries (“LIBs” or “LiBs”) comprise an anode, a cathode, and an electrolyte material such as an organic solvent comprising a lithium salt. More specifically, the anode and cathode (collectively, “electrodes”) are formed by mixing either an anode active material or a cathode active material with a binder and a solvent to form a paste or slurry which is then coated and dried on a current collector, such as aluminum or copper, to form a film on the current collector. The anodes and cathodes are then layered or coiled prior to being housed in a pressurized casing containing an electrolyte material, which all together forms a lithium ion battery.

The binder serves to adhere the active materials to the current collector in a suitable coating. It is important that the binder facilitate maintenance sufficient contact of the active material with the current collector. Further, it has been important to select a binder that is mechanically compatible with the electrode active material(s) such that it is capable of withstanding the degree of expansion and contraction of the electrode active material(s) during charging and discharging of the battery. The binder must also be sufficient to withstand the manipulation of the electrode as it is fit into the battery casing.

Accordingly, binders such as cellulosic binder or cross-linked polymeric binders have been used to provide good mechanical properties. However, in conventional electrodes binders selected generally require environmentally unfriendly or toxic solvents for processing.

### SUMMARY OF THE INVENTION

Disclosed herein is an electrode comprising a current collector and an active layer on the current collector, wherein the active layer comprises electrode active particles, electrically conducting material and a binder wherein the binder comprises a polymer selected from the group consisting of polyacrylamides, polymethacrylic acid, and polyacrylic acid or salts thereof.

Also disclosed herein is an energy storage device comprising such electrode.

Further disclosed herein is a method of making such electrode comprising providing a slurry comprising the electrically conductive elements, the binder and the electrode active material in water, alcohol or a combination thereof, and coating the slurry onto a current collector, and drying to remove the solvent.

### BRIEF DESCRIPTION OF THE DRAWINGS

The following is a brief description of the drawings wherein like elements are numbered alike and which are presented for the purposes of illustrating the exemplary embodiments disclosed herein and not for the purposes of limiting the same.

FIG. 1 is a diagram of an example of an electrode as disclosed herein;

FIG. 2 is a flow chart showing an example of a method that can be used to make the electrode disclosed herein;

FIG. 3 is a depiction of the electrode arrangement in pouch cell devices; and

FIG. 4 is a depiction of a schematic cutaway diagram showing aspects of an energy storage device (ESD).

### DETAILED DESCRIPTION OF THE INVENTION

A more complete understanding of the components, processes, and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

Disclosed herein is an electrolytic cell that comprises a housing that comprises electrodes (an anode and a cathode). The housing comprises an electrolyte that contacts the anode and the cathode. Both of the electrodes (the anode and the cathode) comprises a current collector upon which is disposed an active layer. The active layer may be disposed upon an optional adhesive layer that contacts the electrode.

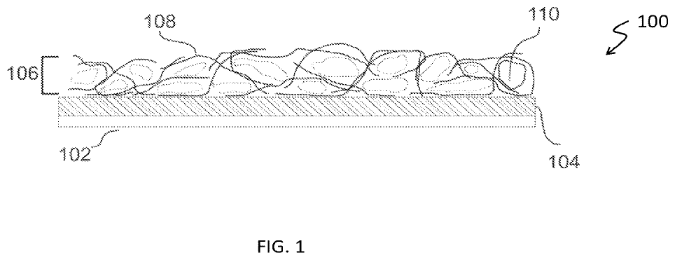

FIG. 1 is a diagram of one example of an electrode (an anode or a cathode) as disclosed herein. In the example shown, electrode 100 comprises current collector 102 and active layer 106. Electrode 100 may optionally include an adhesion layer 104. As an example, adhesion layer 104 comprises a material that promotes adhesion between current collector 102 and active layer 106. The active layer 106 comprises electrode active material 110 in a binder, and electrically conductive elements 108. The electrically conductive elements can be high aspect ratio elements.

The current collector 102 is a conductive element. The current collector can comprise a metal (e.g. substantially pure metal or a metal alloy, etc.) As another example, current collector 102 can be in the form of a metal strip or metal foil. For example, the current collector 102 can be an aluminum foil or strip, an aluminum alloy foil or strip, a copper foil or strip, or copper alloy foil or strip. Current collector 102 can have a thickness of no greater than 15 μm (microns), no greater than 10 μm, no greater than 8 μm or no greater than 5 μm. In some embodiments, at the same time the current collector can have a thickness of at least 3 μm. For example, the current collector 102 can have a thickness of 3 to 15 μm, or 6 μm and about 8 μm. As another example, current collector 102 is an aluminum foil or an aluminum alloy foil, having a thickness a thickness of 5 to 7 μm.

The active layer 106 comprises an electrically conductive material, a binder material, and an electrode active material. The active layer can be manufactured by mixing the electrically conductive material, the binder material, and the electrode active material with a solvent to form a mixture. The mixture can be applied to the current collector directly or onto an adhesive layer which can be adhered to the current collector. If an adhesive layer is used it can be electrically conductive. The mixture can be dried to remove the solvent leaving behind a solid active layer.

### Electrically Conductive Elements

The electrically conductive elements (also referred to as electrically conductive material) can comprise carbon. For example, the conductive elements can be high aspect ratio carbon elements. The term “high aspect ratio carbon elements” refers to carbonaceous elements having a size in one or more dimensions (the “major dimension(s)”) significantly larger than the size of the element in a transverse dimension (the “minor dimension”). The high aspect ratio carbon elements can comprise a substantially cylindrical network of carbon atoms. The electrically conductive material can comprise carbon nanotubes or a plurality of bundles of carbon nanotubes.

The electrically conductive material can form an electrically conducting percolating network that can transmit an electrical current between any two separated points located on a surface of the solid active layer (without the solvent in it). In other words, an electrical current can be transmitted from one surface or end to an opposing surface or end of the active layer by virtue of physical contacts or electron hopping between the electrically conductive elements in the electrode active layer. The percolating network can comprise voids between the high aspect ratio carbon elements that can contain or house the electrode active materials. The high aspect ratio electrically conductive material can be substantially oriented in the electrode active layer 106 in a direction substantially parallel to the current collector to facilitate conducting electrical current from one end of the electrode to the other while still maintaining some lesser orientation through the thickness of the active layer.

The electrically conductive material can be present in the mixture in amounts of 0.1 to 1.3, or 0.15 to 1.2, or 0.3 to 1 weight percent, based on the total weight of the mixture (the mixture comprises the electrically conductive material, the electrode active material, the binder material and a solvent). The electrically conductive material can be present in the active layer in amounts of 0.2 to 3.5, or 0.3 to 3, or 0.5 to 2 weight percent based on total weight of solids in the active layer (total weight solids comprises electrically conductive material, the binder material, the electrode active material without the solvent).

The high aspect ratio carbon elements can be single wall carbon nanotubes (SWCNTs), multiwall carbon nanotubes (MWNTs), or a mixture of both.

The single wall carbon nanotubes can have an outer diameter of 0.5 to 5.0 nanometers, preferably 1.0 to 3.5 nanometers. The single wall carbon nanotubes can have an aspect ratio (length to diameter ratio) greater than about 2.0, preferably greater than 5.0, preferably greater than 10.0, greater than 50 and more preferably greater than 100. In an exemplary embodiment, the single wall carbon nanotubes can have an average aspect ratio of 5 to 200.

The single wall carbon nanotubes can have a length greater than 6 nanometers, preferably greater than 10 nanometers, preferably greater than 15 nanometers, preferably greater than 30 nanometers, preferably greater than 50 nanometers, more preferably greater than 100 nanometers, preferably greater than 1 micrometer, preferably greater than 5 micrometers, preferably greater than 10 micrometers, and more preferably greater than 15 micrometers up to at least 200 micrometers. In an exemplary embodiment, the single wall carbon nanotubes can have an average length of 10 nanometers to 20 micrometers, preferably 20 nanometers to 15 micrometers.

The single wall carbon nanotubes can be present in the mixture of electrically conductive material, binder material, electrode active material and solvent in an amount of 0.1 to 2 weight percent based on the total weight of the mixture. For example, the amount of single wall nanotubes in the mixture can be 0.1 to 0.3, or 0.15 to 9.25 weight percent. As another example, the amount of single wall nanotube in the mixture can be 0.4 to 2 weight percent.

The single wall carbon nanotubes can be present in the electrode active layer (electrically conductive material, binder material, and electrode active material without the solvent) in an amount of 0.2 to 4 wt %, based on the entire weight of the electrode active layer. For example, the amount of single wall nanotubes in the electrode active layer can be 0.2 to 0.6, or 0.3 to 0.5 weight percent. As another example, the amount of single wall nanotube in the electrode active layer can be 0.5 to 4 weight percent.

The number of carbon walls in the multiwall carbon nanotubes can be 2 or more, 5 or more, 10 or more, 50 or more. The multi-wall carbon nanotubes can comprise an average of between 3 layers to 15 layers, 4 to 12 layer, 5 to 10 layers, 6 to 8 layers.

The active layer 106 can comprise multi-wall carbon nanotubes and single-wall carbon nanotubes. The multi-wall carbon nanotubes swell more than single-wall carbon nanotubes when wetted with an electrolyte in an energy storage device in which electrode 100 is located. For example, the multi-wall carbon nanotubes can swell at least 15%, or at least 25% or at least 50% more than single-wall carbon nanotubes when wetted with an electrolyte in an energy storage device in which electrode 100 is located. For example, a length of the multi-wall carbon nanotubes can expand at least 15%, or at least 25% or at least 50% more than a length of the single-wall carbon nanotubes when wetted with the electrolyte. As another example, the multi-wall carbon nanotubes swell up to 50% when wetted (e.g., a length of the multi-wall carbon nanotubes is 50% larger after wetting with an electrolyte, and/or a diameter of the multi-wall carbon nanotubes is 50% larger after wetting, etc.).

The multiwall carbon nanotubes can have an outer diameter of 2.0 to 50 nanometers, 5.0 to 40 nanometers, or 6 to 10 nanometers. The multiwall carbon nanotubes can have a length greater than 10 nanometers, greater than 15 nanometers, greater than 30 nanometers, greater than 50 nanometers, greater than 100 nanometers, greater than 500 nanometers, greater than 1 micrometer, greater than 5 micrometers, greater than 10 micrometers, or greater than 15 micrometers. At the same time, the multi-wall carbon nanotubes can have an average length up to 25 micrometers or up to 20 micrometers. In exemplary embodiments, the multiwall carbon nanotubes have an average length of 10 nanometers to 20 micrometers, or 20 nanometers to 15 micrometers. The multiwall carbon nanotubes can have an aspect ratio (length to diameter ratio) greater than 5.0, greater than 10.0, greater than 50, greater than 100, or greater than 500.

The electrode can comprise multiwall carbon nanotubes that are relatively longer in comparison to multiwall carbon nanotubes comprised in related art electrodes. The use of relatively longer multiwall carbon nanotubes in electrodes is found to have beneficial mechanical and/or electrical properties. For example, multiwall carbon nanotubes provide relatively good power at low densities. As another example, shorter multiwall carbon nanotubes generally do not swell (e.g., expand) as much as longer multiwall carbon nanotubes. As such use of shorter multiwall carbon nanotubes loses (or reduces) some of the beneficial properties associated with swelling of the carbon nanotubes. As an extreme example, carbon black does not exhibit swelling because carbon black is merely particles of carbon without entanglement such as the entanglement exhibited by a set of multiwall carbon nanotubes. An indication that a length of a certain amount of multiwall carbon nanotubes have a length exceeding a threshold length and thus have sufficient swelling properties is an observation during a calendaring process-a relatively larger amount of pressure or effort to calendar the slurry in connection with applying to the foil is indicative that the collective swelling (e.g., an average swelling) of the multiwall carbon nanotubes in the active layer will satisfy a certain performance threshold. However, multiwall carbon nanotubes are generally difficult to process.

The processing of the multiwall carbon nanotubes in connection with preparing/forming the active layer and/or electrode is gentler than processes for related art electrodes. As such, the processes according to various embodiments maintain longer multiwall carbon nanotubes (e.g., less multiwall carbon nanotubes are crushed, fragmented, broken, etc.). In some embodiments, the active layer of the electrode comprises a set of multiwall carbon nanotubes having an average length that is more an average length of the multiwall carbon nanotubes in related art electrodes. According to various embodiments, a distribution of lengths of the set of multiwall carbon nanotubes is skewed towards a nominal length a multiwall carbon nanotube. As an example, the nominal length of a multiwall carbon nanotube is about 16 microns. For example, the multiwall carbon nanotubes are processed and/or applied in a manner that reduces or minimizes fracturing or breaking of multiwall carbon nanotubes. The lengths of the multiwall carbon nanotubes in the network of high aspect ratio carbon elements are generally the nominal length of the multiwall carbon nanotubes, or a length of such the multiwall carbon nanotubes tend to be more heavily skewed to the nominal length. In some embodiments, at least 75% of the multiwall carbon nanotubes within the network of high aspect ratio carbon elements are within 10% of the nominal length (e.g., between 13.4 microns to about 15 microns). In some embodiments, at least 75% of the multiwall carbon nanotubes within the network of high aspect ratio carbon elements have a length of at least 12 microns. In some embodiments, at least 75% of the multiwall carbon nanotubes within the network of high aspect ratio carbon elements have a length of at least 13 microns. In some embodiments, at least 50% of the multiwall carbon nanotubes within the network of high aspect ratio carbon elements are within 10% of the nominal length (e.g., between 13.4 microns to about 15 microns). In some embodiments, at least 50% of the multiwall carbon nanotubes within the network of high aspect ratio carbon elements have a length of at least 12 microns. In some embodiments, at least 50% of the multiwall carbon nanotubes within the network of high aspect ratio carbon elements have a length of at least 8 microns. In some embodiments, at least 50% of the multiwall carbon nanotubes within the network of high aspect ratio carbon elements have a length of at least 13 microns.

According to various embodiments, a distribution of lengths of the set of multiwall carbon nanotubes is skewed towards a nominal length a multiwall carbon nanotube. For example, the multiwall carbon nanotubes are processed and/or applied in a manner that reduces or minimizes fracturing or breaking of multiwall carbon nanotubes. The lengths of the multiwall carbon nanotubes in the network of high aspect ratio carbon elements are generally the nominal length of the multiwall carbon nanotubes, or a length of such the multiwall carbon nanotubes tend to be more heavily skewed to the nominal length.

In some embodiments, at least 75% of the multiwall carbon nanotubes within the network of high aspect ratio carbon elements are within 10% of the nominal length (e.g., between 13.4 micrometers to about 15 micrometers). In some embodiments, at least 75% of the multiwall carbon nanotubes within the network of high aspect ratio carbon elements have a length of at least 12 micrometers. In some embodiments, at least 75% of the multiwall carbon nanotubes within the network of high aspect ratio carbon elements have a length of at least 13 micrometers. In some embodiments, at least 50% of the multiwall carbon nanotubes within the network of high aspect ratio carbon elements are within 10% of the nominal length (e.g., between 13.4 micrometers to about 15 micrometers). In some embodiments, at least 50% of the multiwall carbon nanotubes within the network of high aspect ratio carbon elements have a length of at least 12 micrometers. In some embodiments, at least 50% of the multiwall carbon nanotubes within the network of high aspect ratio carbon elements have a length of at least 13 micrometers.

The multiwall carbon nanotubes can be present in the mixture (the mixture comprises the electrically conductive material, the electrode active material, the binder material and a solvent) in an amount of 0.3 to 1.0 weight percent, preferably 0.4 to 0.9 weight percent based on the total weight of the mixture. The multiwall carbon nanotubes are present in the solid anode active layer (the solid active layer comprises the electrically conductive material, the binder material, the electrode active material without the solvent) in an amount of 0.8 to 2.6 wt %, preferably 1.0 to 1.8 wt %, based on the entire weight of the solid anode active material.

In an example where both multiwall and single wall carbon nanotubes are used, the ratio of the weight of the multiwall carbon nanotubes to the weight of the single wall carbon nanotubes in the mixture or in the solid active material layer can be at least 2:1.

In one example, three-dimensional network of high aspect ratio carbon elements 108 comprises carbon nanotubes, and the carbon nanotubes are only multi-wall carbon nanotubes and/or fragments of such carbon nanotubes.

In another example, the multiwall carbon nanotubes are present in the mixture or in the solid anode active material layer in an amount that is at least twice the amount of the single wall carbon nanotubes, based on the weight of the conductive materials.

The network of three-dimensional network of high aspect ratio carbon elements 108 can comprise at least 99% carbon by weight.

The three-dimensional network of high aspect ratio carbon elements 108 can comprise an electrically interconnected network of carbon elements exhibiting connectivity above a percolation threshold and wherein the network defines one or more highly electrically conductive pathways having a length greater than 100 μm. The percolation threshold is one where the conducting elements contact one another to provide an electrically conducting network measured across any two points on any surface of the network.

### Electrode Active Material

The active material typically will be different in for an anode than for a cathode.

For example, the anode active material can comprise silicon (Si), germanium (Ge), tin (Sn), lead (Pb), antimony (Sb), bismuth (Bi), zinc (Zn), aluminum (Al), titanium (Ti), nickel (Ni), cobalt (Co), cadmium (Cd); alloys or two or more thereof or alloys thereof with other elements; oxides, carbides, nitrides, sulfides, phosphides, selenides, and tellurides of those metals and their mixtures or lithium-containing composites: salts and hydroxides of Sn: lithium titanate, lithium manganate, lithium aluminate, lithium-containing titanium oxide, lithium transition metal oxide; prelithiated versions thereof; particles of Li, Li alloy, or surface stabilized Li having at least 60% by weight of lithium; or combinations thereof. The active material can comprise graphite as an alternate or in addition to the above. As one example, the anode active material can comprise a silicon oxide and/or carbon silicon oxide. Such anode active material comprising a silicon oxide or carbon silicon oxide can further comprise graphite.

For example, the cathode active material can comprise a lithium cobalt oxide (LCO, sometimes called “lithium cobaltate” or “lithium cobaltite”). Examples of LCO formulations include LiCoO2; lithium nickel manganese cobalt oxide (NMC, with a variant formula of LiNiMnCo); lithium manganese oxide (LMO with variant formulas of LiMn2O4, Li2MnO3 or the like, or a combination thereof); lithium titanate oxide (LTO, with one variant formula being Li4Ti5O12); lithium iron phosphate oxide (LFP, with one variant formula being LiFePO4), lithium nickel cobalt aluminum oxide (and variants thereof as NCA) as well as other similar other materials. Other variants of the foregoing may be included.

Where NMC is used as an active material, a nickel rich NMC may be used. For example, the variant of NMC may be LiNixMnyCo(1-x-y), where x is equal to or greater than about 0.7. 0.75. 0.80, 0,85 or more, y is equal to or greater than 0.1, 0.15, 0.2 or 0.25, and x+y is less than 1. For example, NMC811 may be used where x is about 0.8 and y is about 0.1. Alternatively, the active material can include oxides of lithium nickel manganese cobalt (LiNixMnyCo₂O2). Variants of this formula that may be used in the active material layer include NMC 111 (detailed below). NMC532 (LiNi0.5Mn0.3Co0.2O2), NMC622 (LiNi0.6Mn0.2Co0.2O2), or a combination thereof.

In an embodiment, the active material used in both electrodes (anode and/or cathode) may also include a nickel-rich combination of nickel, manganese, and cobalt. Lithium-Nickel-Manganese-Cobalt-Oxide (LiNiMnCoO₂), abbreviated as NMC delivers strong overall performance, excellent specific energy, and the lowest self-heating rate of all mainstream cathode powders. The NMC powder may comprise nickel in an amount of 20 to 40 wt %, manganese in an amount of 20 to 40 wt % and cobalt in an amount of 20 to 40 wt %, based on a total weight of the NMC blend, While the term “NMC powder” can refer to a variety of blends, it is desirable to use a blend that comprises 33 wt % nickel, 33 wt % manganese and 33 wt % cobalt. This blend, sometimes referred to as 1-1-1 (NMC 111) is useful for applications that use frequent cycling (automotive, energy storage) due to the reduced material cost resulting from lower cobalt content a nickel-rich combination of nickel, manganese, and cobalt (NMC). The NMC powder may comprise nickel in an amount of 20 to 40 wt %, manganese in an amount of 20 to 40 wt % and cobalt in an amount of 20 to 40 wt %, based on a total weight of the NMC blend. While the term “NMC powder” can refer to a variety of blends, it is desirable to use a blend that comprises 33 wt % nickel, 33 wt % manganese and 33 wt % cobalt. This blend, sometimes referred to as 1-1-1 is useful for applications that use frequent cycling (automotive, energy storage) due to the reduced material cost resulting from lower cobalt content. Lithium-Nickel-Manganese-Cobalt-Oxide (LiNiMnCoO₂), delivers strong overall performance, excellent specific energy, and the lowest self-heating rate of all mainstream cathode powders.

As noted above, the active material can be contained or housed in the network of high aspect ratio active materials present in the electrode active layer. The active material can be present in the mixture used to form the electrode in amount of 40 to 75 wt %, preferably 50 to 70 wt %, based on a total weight of the electrode mixture (the mixture used to manufacture the electrode active layer which contains the electrode polymeric binder material, the electrode active material, the electrically conducting material and the solvent). The electrode active material is present in the electrode active layer (which is devoid of the solvent) in an amount of 95 to 98.5 wt %, based on a total weight of the cathode active layer.

### Binders

The binders described herein can provide the ability to manufacture the electrode using water and/or alcohols as the solvent. These binders can also provide good adhesive binding force, good dispersion of slurry components (i.e. electrode active material, binder and electrically conducting material), and/or good stability during battery charging and discharging. The binders arc polymers and are characterized by the presence of hydrophilic pendant groups that facilitate at least processing in water and/or alcohol and good dispersion of slurry components while decreasing solubility of the binder in a carbonate based electrolyte. The binders are characterized in that they can provide good mechanical properties and/or electrochemical and chemical stability when used in the energy storage device (e.g. battery, particularly Lithium ion battery). The binders described herein are selected from the group consisting of polyacrylamides, polymethacrylic acids or a salt thereof, and polyacrylic acids or a salt thereof. These polymers can be homopolymers.

For example, the polymer which is the binder can have the formula
the formula:

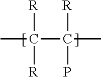

where R is independently in each occurrence H, but one of R can be an alkyl group of 1 to 3 carbon atoms. P can be —COOR¹ where R¹ is H, a single valent metal ion such as Nat⁺, K⁺, or Li⁺, or a hydrocarbon group of 1 to 3 carbon atoms, preferably R¹ is H or a single valent metal ion. Alternatively, P can be —C(O)N(R²)₂ where R² is independently in each occurrence H, or an alkyl group of 1 to 3 carbon atoms, preferably 1 carbon atom.

The polyacrylamides, polymethacrylic acid, polyacrylic acid can be made by known polymerization techniques for ethylenically unsaturated monomers—e.g., addition polymerization. The polymerization could be for example, solution polymerization or emulsion polymerization.

The weight average molecular weight of the polymers as determined by gel permeation chromatography can be 5.000 to 2,000,000 grams per mole, or 10,000 to 1,000,000 grams per mole.

If desired the polymer can include cross-linking functional groups or a cross-linking agent can be added such that the binder polymer can be cross-linked before completion of the production of the electrode active layer.

The polymer as described above can be used as the only polymer in the binder. Alternatively, the polymers as described above can be used in a blend with a second different polymers as described above. As yet another alternative, the polymer described above can be blended with one or more other known polymeric binders. However, to utilize the full value of the above described polymers, the additional polymer is preferably also soluble or dispersible in water, alcohol or combinations thereof. When used in a blend the above described polymer preferably comprise at least 10, at least 20, at least 30, at least 40, at least 50, at least 60, at least 70, at least 80, at least 90, at least 95, or at least 99 weight percent of the blend based on total weight of the polymers in the blend.

Forming the Electrode

The electrode can be produced by first preparing a mixture (sometime referred to as a slurry) of the electrically conductive elements, the active material and the binder in a solvent. An advantage of the binders as described herein is that a useful slurry can be formed using water, alcohol, or a combination thereof as the solvent. The slurry can then be coated directly onto a current collector or applied to a current collector with an intermediate adhesive layer.

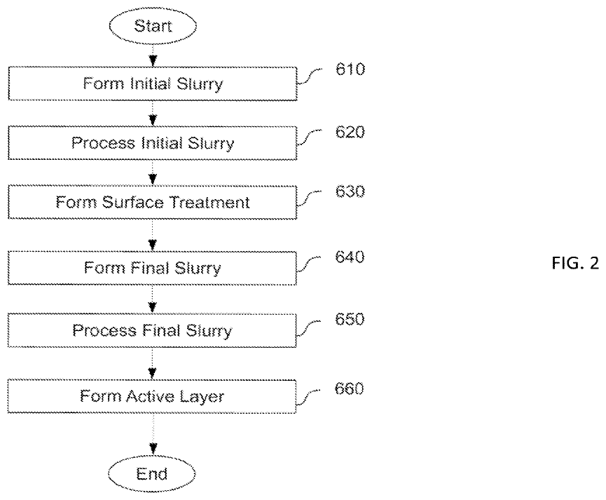

The slurry can be prepared in a single step. Alternatively, the slurry can be prepared according to a multiple step process as shown in the flow chart of FIG. 2 describing an example of a process 600 to provide with respect to electrode 100 of FIG. 1. At 610, an electrically conducting material, e.g., high aspect ratio carbon elements, and a surface treatment material (e.g., a surfactant, the binder material as described herein, or both) are combined with a solvent (e.g. water, alcohol, or a combination thereof) to form an initial slurry.

At 620, the initial slurry is processed to ensure good dispersion of the solid materials in the slurry. This processing can include introducing mechanical energy into the mixture of solvent and solid materials (e.g., using a sonicator, which may sometimes also be referred to as a “sonifier”) or other suitable mixing device (e.g., a high shear mixer). For example, the mechanical energy introduced into the mixture can be at least 0.4 kilowatt-hours per kilogram (kWh/kg), 0.5 kWh/kg, 0.6 kWh/kg, 0.7 kWh/kg, 0.8 kWh/kg, 0.9 kWh/kg, 1.0 kWh/kg, or more. For example, the mechanical energy introduced into the mixture per kilogram of mixture may be in the range of 0.4 kWh/kg to 1.0 kWh/kg or any subrange thereof such as 0.4 kWh/kg to 0.6 kWh/kg.

As one example, an ultrasonic bath mixer may be used. As another example, a probe sonicator may be used. Probe sonication may be significantly more powerful and effective when compared to ultrasonic baths for nanoparticle applications. High shear forces created by ultrasonic cavitation have the ability to break up particle agglomerates and result in smaller and more uniform particles sizes. Among other things, sonication can result in stable and homogenous suspensions of the solids in the slurry. Generally, this results in dispersing and deagglomerating and other breakdown of the solids. Examples of probe sonication devices include the Q Series Probe Sonicators available from QSonica LLC of Newtown, Connecticut. Another example includes the Branson Digital SFX-450 sonicator available commercially from Thomas Scientific of Swedesboro, New Jersey.

The localized nature of each probe within the probe assembly can occasionally result in uneven mixing and suspension. Such may be the case, for example, with large samples. This may be countered by use of a setup with a continuous flow cell and proper mixing. For example, with such a setup, mixing of the slurry will achieve reasonably uniform dispersion.

The initial slurry, once processed can have a viscosity in the range of 5,000 cps to 25,000 cps or any subrange thereof, e.g., 6,000 cps to 19,000cps.

At optional step 630, (used, for example, if the binder was not added in step 610) the binder or additional binder can be applied as a surface treatment may be fully or partially formed on the electrically conductive material (e.g., high aspect ratio carbon elements) in the initial slurry. In some embodiments, at this stage the surface treatment may self-assemble.

The resulting surface treatment can include functional groups or other features which, as described in further steps below, may promote adhesion between the high aspect ratio carbon elements and active material particles. For example, functional groups on the binder can provide the stated surface treatment.

At 640, the active material particles may be combined with the initial slurry to form a final slurry containing the active material particles along with the high aspect ratio carbon elements with the surface treatment formed thereon.

The active material may be added directly to the initial slurry. Alternatively, the active material may first be dispersed in a solvent (e.g., water, alcohol or a combination thereof using the techniques described above with respect to the initial solvent) to form an active material slurry. This active material slurry may then be combined with the initial slurry to form the final slurry.

At 650, the final slurry is processed to ensure good dispersion of the solid materials in the final slurry. Any suitable mixing process known in the art may be used. For example, this processing may use the techniques described above with reference to 620. Alternatively, a planetary mixer such as a multi-axis (e.g., three or more axis) planetary mixer can be used. The planetary mixer can feature multiple blades, e.g., two or more mixing blades and one or more (e.g., two, three, or more) dispersion blades such as disk dispersion blades.

During 650, the matrix enmeshing the active material may fully or partially self-assemble as interactions between the surface treatment (e.g. binder) and the active material promote the self-assembly process.

In some embodiments the final slurry, once processed will have a viscosity in the range of 1,000 cps to 10,000 cps or any subrange thereof, e.g., 2.500 cps to 6000 cps.

Viscosity can be measured at 25° C, at shear rates of 0.1 to 100 s⁻¹ using a suitable commercial rheometer such as a TA Instruments model HR10.

At 660, the active layer 106 is formed from the final slurry. In some embodiments, final slurry may be cast wet directly onto the current collector conductive layer 102 (or optional adhesion layer 104) and dried. As an example, casting may be by applying at least one of heat and a vacuum until substantially all of the solvent and any other liquids have been removed, thereby forming the active layer 106. Protecting various parts of the underlying layers may be desirable. For example, protecting an underside of the conductive layer 102 may be desirable where the electrode 100 is intended for single-sided operation. Protection may include, for example, protection from the solvent by masking certain areas, or providing a drain to direct the solvent away.

In another example, the final slurry may be at least partially dried elsewhere before being transferred onto the adhesion layer 104 or the conductive layer 102 to form the active layer 106, using any suitable technique (e.g., roll-to-roll layer application). As another example, the wet combined slurry may be placed onto an intermediate material with an appropriate surface and dried to form the layer (e.g., the active layer 106). While any material with an appropriate surface may be used as the intermediate material, exemplary intermediate material includes PTFE as subsequent removal from the surface is facilitated by the properties thereof. The layer can be formed in a press to provide a layer that exhibits a desired thickness, area and density.

In yet another example, the final slurry may be formed into a sheet, and coated onto the adhesion layer 104 or the conductive layer 102 as appropriate. For example, the final slurry can be applied to through a slot die to control the thickness of the applied layer. As another example, the slurry may be applied and then leveled to a desired thickness, e.g., using a doctor blade. A variety of other techniques may be used for applying the slurry. For example, coating techniques may include, without limitation: comma coating: comma reverse coating; doctor blade coating; slot die coating; direct gravure coating; air doctor coating (air knife); chamber doctor coating; off set gravure coating; one roll kiss coating: reverse kiss coating with a small diameter gravure roll; bar coating; three reverse roll coating (top feed); three reverse roll coating (fountain die); reverse roll coating and others.

The viscosity of the final slurry may vary depending on the application technique. For example, for comma coating, the viscosity may range between about 1,000 cps to about 200,000 cps. Lip-die coating provides for coating with slurry that exhibits a viscosity of between about 500 cps to about 300,000 cps. Reverse-kiss coating provides for coating with slurry that exhibits a viscosity of between about 5 cps and 1,000 cps. In some applications, a respective layer may be formed by multiple passes.

Where desired, the active layer 106 formed from the final slurry can be compressed (e.g., using a calendaring apparatus) before or after being applied to the electrode 100. The slurry can be partially or completely dried (e.g., by applying heat, vacuum or a combination thereof) prior to or during the compression process. For example, in some embodiments, the active layer may be compressed to a final thickness (e.g., in the direction normal to the current collector layer 102) of less than 90%, 80%, 70%, 50%, 40%, 30%, 20%, 10% or less of its pre-compression thickness.

When a partially dried layer is formed during a coating or compression process, the layer can be subsequently fully dried, (e.g., by applying heat, vacuum or a combination thereof). In some embodiments, substantially all of the solvent is removed from the active layer 106.

Solvents used in formation of the slurries can be recovered and recycled into the slurry-making process.

The active layer 106 can be compressed, e.g., to break some of the constituent high aspect ratio carbon elements or other carbonaceous material to increase the surface area of the respective layer. This compression treatment can increase one or more of adhesion between the layers, ion transport rate within the layers, and the surface area of the layers. In various embodiments, compression can be applied before or after the respective layer is applied to or formed on the electrode 100.

Where calendaring is used to compress active layer 106, the calendaring apparatus may be set with a gap spacing equal to less than 90%, 80%, 70%, 50%, 40%, 30%, 20%, 10% or less of the layer's pre-compression thickness (e.g., set to about 33% of the layer's pre-compression thickness). The calendar rolls can be configured to provide suitable pressure, e.g., greater than 1 ton per cm of roll length, greater than 1.5 ton per cm of roll length, greater than 2.0 ton per cm of roll length, greater than 2.5 ton per cm of roll length, or more. The post compression active layer can have a density in the range of 1 g/cc to 10 g/cc, or any subrange thereof such as 2.5 g/cc to 4.0 g/cc. The calendaring process can be conducted at a temperature in the range of 20° C, to 140° C, or any subrange thereof. In some embodiments active layer 106 may be pre-heated prior to calendaring, e.g., at a temperature in the range of 20° C, to 100° C, or any subrange thereof.

The process 600 may include any of the following features (individually or in any suitable combination):

The initial slurry has a solid content in the range of 0.1%-20.0% (or any subrange thereof) by weight and/or the final slurry has a solid content in the range of 10.0%-80% (or any subrange thereof) by weight.

As noted, a scaffold or matrix of the electrically conductive and binder can hold the active material particles together to form a cohesive layer that is also strongly attached to the metallic current collector. Such active material structure can be created during slurry preparation and subsequently in a roll to roll (“R2R”) coating and drying process. One of the main advantages of this technology is its scalability and “drop-in” nature because various embodiments are compatible with conventional electrode manufacturing processes.

The matrix can be formed during a slurry preparation using the techniques described herein: high aspect ratio carbon materials are properly dispersed and as desired chemically functionalized using, e.g., as described above with reference to process 600 of FIG. 2. The chemical functionalization is designed to form an organized self-assembled structure with the surface of active material particles, e.g. NMC particles for use in a cathode or silicon particles (“Si”) or Silicon Oxide (“SiOx”) particles in the case of an anode. The so formed slurry may be based on water and/or alcohol solvents for cathodes and water for anodes, and such solvents are very easily evaporated and handled during the manufacturing process. Electrostatic interactions promote the self-organized structure in the slurry, and after the drying process the bonding between the so formed carbon matrix with active material particles and the surface of the current collector is promoted by the surface treatment (e.g., functional groups on the matrix) as well as the strong entanglement of the active material in the carbon matrix.

The mechanical properties of the electrodes can be modified depending on the application, and the mass loading requirements by tuning the surface functionalization vs. entanglement effect.

After coating and drying, the electrodes can undergo a calendaring step to control the density and porosity of the active material. In NMC cathode electrodes, densities of 3.5 g/cc or more and 20% porosity or more can be achieved. Depending on mass loading and lithium ion battery cell requirements the porosity can be optimized. For silicon oxide or silicon based anodes, the porosity can be specifically controlled to accommodate active material expansion during the lithiation process.

The teachings herein may provide a reduction in $/kWh of up to 20%. By using water, alcohol or mixed water/alcohol as the solvents, these solvents are easily evaporated, the electrode production throughput can be higher, and more importantly, the energy consumption from the long driers can be significantly reduced. The conventional recovery systems needed when NMP or similar compounds are used as the solvent are also much simplified when water, alcohol or combinations thereof are used.

The teachings herein provide an active layer having a 3D matrix that can dramatically boosts electrode conductivity by a factor of 10× to 100× compared to electrodes using conventional binders such as PVDF, which enables fast charging at a battery level.

Thick electrode coatings in cathode up to 150 μm per side (or more) of current collector are possible with this technology. The solvents used in the slurry in combination with a strong 3D carbon matrix are designed to achieve thick wet coatings without cracking during the drying step. Thick cathodes with high capacity anodes are what enable a substantial jump in energy density reaching 400 Wh/kg or more.

### Energy Storage Device

Once the electrode 100 has been assembled, the electrode 100 may be used to assemble the energy storage device. Assembly of the energy storage device may follow conventional steps used for assembling electrodes with separators and placement within a housing such as a canister or pouch, and further may include additional steps for electrolyte addition and scaling of the housing.

One exemplary embodiment includes a Li-ion battery energy storage devices in a pouch cell format that combines Ni-rich NMC active material in the cathodes and SiOx and graphite blend active material in the anodes, where both anodes and cathodes are made using a 3D carbon matrix process as described herein.

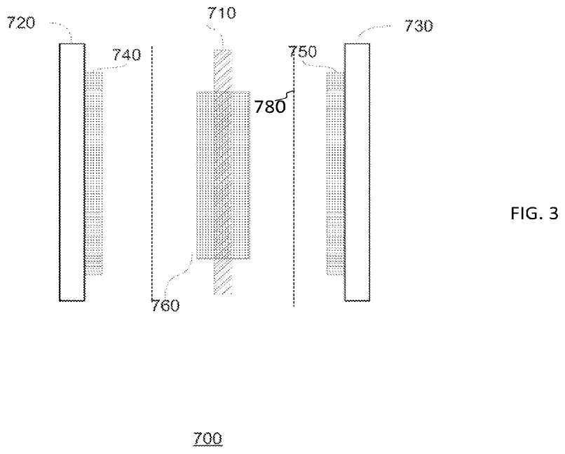

A schematic of the electrode arrangement one example of pouch cell devices is shown in FIG. 3. As shown, cathode active layers 760 (e.g., active layers according to various embodiments disclosed herein) on opposing sides of a current collector 710 (e.g., an aluminum foil current collector) to from a double sided cathode disposed between two single sided anodes. The single sided anodes each have an anode layer 740 or 750 (e.g., an active layer comprising a network of carbon elements such as disclosed herein) disposed on a current collector 720 or 730 (e.g. a copper current collector). The electrodes are be separated by permeable separator material 780 wetted with electrolyte (not shown). The arrangement can be housed in a pouch cell of the type well known in the art.

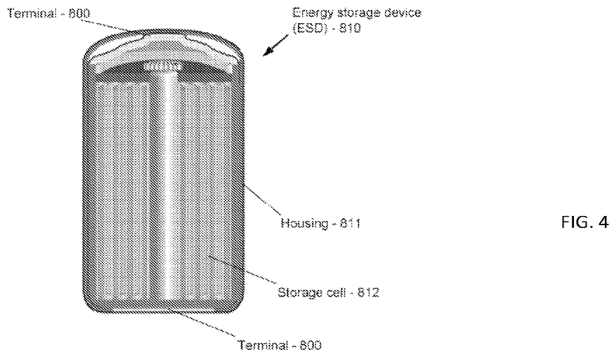

In FIG. 4, a cross section of an energy storage device (ESD) 810 is shown. The energy storage device (ESD) 810 includes a housing 811. The housing 811 has two terminals 800 disposed on an exterior thereof. The terminals 800 provide for internal electrical connection to a storage cell 812 contained within the housing 811 and for external electrical connection to an external device such as a load or charging device (not shown). The energy storage devices disclosed herein may be batteries, capacitors, ultracapacitors, or the like.

### EXAMPLES

A sodium salt of polymethacrylic acid is dissolved in water to reach a clear solution in 10% concentration (weight ratio). The solubility of this polymer in water is greater than 30% by weight. An initial slurry of electrically conducive material in water and/or alcohol solvent is mixed with the polymer solution, active materials and more water/alcohol solvent. The amount of the polymer in the total solid content (including carbon conductive, active materials and binders, but without solvent) is about 1% by weight. The mixture is subject to mixing process as described above to give a final slurry. The slurry is coated onto metal foil and dried to form an electrode.

This disclosure further encompasses the following aspects.

Aspect 1: n electrode comprising a current collector and an active layer on the current collector, wherein the active layer comprises electrode active particles, electrically conducting material and a binder wherein the binder comprises a polymer selected from the group consisting of polyacrylamides, polymethacrylic acid, polyacrylic acids; and salts thereof.

Aspect 2. The electrode of Aspect 1 wherein the electrically conductive elements form a network.

Aspect 3. The electrode of any of the preceding Aspects wherein the electrically conductive elements high aspect ratio carbon elements.

Aspect 4. The electrode of Aspect 3 wherein the high aspect ratio carbon elements comprise carbon nanotubes.

Aspect 5. The electrode of any one of Aspects 1-4 wherein the polymer comprises repeat units of the formula:

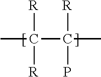

where R is independently in each occurrence H, or one of R can be an alkyl group of 1 to 3 carbon atoms; and P is —COOR¹ where R¹ is H, a single valent metal ion or P is —C(O)N(R²)₂ where R²is independently in each occurrence H, or an alkyl group of 1 to 3 carbon atoms.

Aspect 6. The electrode of any one of Aspects 1-5 wherein the polymer is a homopolymer.

Aspect 7. An energy storage device comprising the electrode of any one of claims 1-6.

Aspect 8. The energy storage device of Aspect 7 wherein the energy storage device is a pouch cell device.

Aspect 9. The energy storage device of Aspect 7 or 8 comprising a double sided cathode disposed between two single sided anodes, wherein at least one of the cathode or anode is the electrode of any one of claims 1-6.

Aspect 10: The energy storage device of any one of Aspects 7 to 9 comprising an electrolyte between two electrodes, e.g. the cathode and the anode.

Aspect 11: The energy storage device of anyone of Aspects 7-10 further comprising a permeable separator material between electrodes, e.g. the cathode and the anode(s).

Aspect 12; The energy storage device of any one of Aspects 7-11 comprising a housing.

Aspect 13: The energy storage device of Aspect 12 further comprising one, preferably two terminals on an exterior of the housing to provide electrical connection to the electrodes.

Aspect 14. A method of making the electrode of any one of Aspects 1-6 comprising providing a slurry comprising the electrically conductive elements, the binder and the electrode active material in water, alcohol or a combination thereof, and coating the slurry onto a current collector, and drying to remove the solvent.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). Moreover, stated upper and lower limits can be combined to form ranges (e.g. “at least 1 or at least 2 weight percent” and “up to 10 or 5 weight percent” can be combined as the ranges “1 to 10 weight percent”, or “1 to 5 weight percent” or “2 to 10 weight percent” or “2 to 5 weight percent”).

The disclosure may alternately comprise, consist of, or consist essentially of, any appropriate components herein disclosed. The disclosure may additionally, or alternatively, be formulated so as to be devoid, or substantially free, of any components, materials, ingredients, adjuvants or species used in the prior art compositions or that are otherwise not necessary to the achievement of the function and/or objectives of the present disclosure.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

Unless specified to the contrary herein, all test standards are the most recent standard in effect as of the filing date of this application, or, if priority is claimed, the filing date of the earliest priority application in which the test standard appears.

1. An electrode comprising
a current collector, and
an active layer on the current collector, wherein the active layer comprises electrode active particles, electrically conducting material and a binder wherein the binder comprises a polymer selected from the group consisting of polyacrylamides, polymethacrylic acid, polyacrylic acid and salts thereof.

2. The electrode of claim 1 wherein the electrically conductive elements form a network.

3. The electrode of claim 1 wherein the electrically conductive elements comprise high aspect ratio carbon elements.

4. The electrode of claim 3 wherein the high aspect ratio carbon elements comprise carbon nanotubes.

5. The electrode of claim 1 wherein the polymer comprises repeat units of the formula: 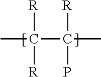
where R is independently in each occurrence H, or one of R can be an alkyl group of 1 to 3 carbon atoms;
P is —COOR¹ where R¹ is H, a single valent metal ion or P is —C(O)N(R²)₂ where R² is independently in each occurrence H, or an alkyl group of 1 to 3 carbon atoms.

6. The electrode of claim 1 wherein the polymer is a homopolymer.

7. An energy storage device comprising the electrode of claim 1.

8. A method of making the electrode of claim 1 comprising
providing a slurry comprising the electrically conductive elements, the binder and the electrode active material in water, alcohol or a combination thereof, and
coating the slurry onto a current collector, and drying to remove the solvent.
